(19) United States
(12) Patent Application Publication
(10) Pub. No.: US 2018/0322565 A1
(43) Pub. Date: Nov. 8, 2018

(54) Method for facilitating live virtual online reverse auctions for property owner services

(71) Applicants: David Craig Joyner, Plano, TX (US); Jonathan David Rosenbaum, Houston, TX (US)

(72) Inventors: David Craig Joyner, Plano, TX (US); Jonathan David Rosenbaum, Houston, TX (US)

(73) Assignee: BidJovi Inc., Houston, TX (US)

(21) Appl. No.: 15/587,327

(22) Filed: May 4, 2017

(51) Int. Cl. G06Q 30/08

(52) U.S. Cl. CPC G06Q 30/08; G06Q 50/16

(57) ABSTRACT

A live virtual online reverse auction system, hereafter referred to as auction, and method that conducts live, virtual reverse auctions between property owners and contractors and/or service professionals, hereafter defined as service professionals, is disclosed herein. The reverse auction system will allow property owners to create service opportunities for the properties they own via uploading images and/or video and details of the service opportunity into the auction engine. The auction engine will request additional information from the property owner to determine the optimal auction settings. Service professionals will enroll in the auction system and provide the auction system with information needed to verify the service professional's status and eligibility to participate in the virtual auction. A notice of the opportunity will be transmitted to the service professionals identified in the system as being eligible for the described service opportunity and the auction will begin. Service professionals will bid for the job until the auction system criteria are satisfied or until the time allotted for the auction expires.

### CROSS-REFERENCE TO RELATED APPLICATIONS

“Not Applicable”

### BACKGROUND OF THE INVENTION

The creation and growth of the Internet has fundamentally transformed global commerce since its initial introduction to the broader world in the early 1990s. Many industries have seen their traditional means of conducting business greatly enhanced by the capabilities that the Internet provides to consumers, producers, distributors, and retailers of goods and services. For the most part, the benefits of the Internet to the facilitation of global commerce have been profoundly impactful. The percentage of sales conducted through e-commerce has grown at an incredible rate as the parties involved in e-commerce transactions have increasingly embraced the Internet as a means of doing business including increased trust in the security of completing virtual transactions. One method of doing business that has been greatly enhanced by the Internet is the auction.

Prior to the advent of the internet, auctions have been conducted using a “live” auction format with an auctioneer and the auction participants located in the same physical area. That is to say, the only way to conduct an auction would be to have participants physically attend in person. Prior to the advent of the Internet, there were some technological advances that did allow for the “live” auction format to be expanded. First, the invention of the telephone allowed the actual buyer of the product to be at a separate location and simply telephone in their bids to a local representative during the live auction method. Of course, this still meant a party had to be physically present to signal the auctioneer in order to place a bid. Second, the fax machine allowed some bidders to fax to the auction company a sheet containing their maximum or minimum bid which the auctioneer could use to keep an auction going even if the bidders present at the location had ceased bidding.

However, with the advent of the Internet, the normal dynamics of the “live” auction have been changed dramatically. Now, a bidder could simply log into a portal or some other user interface and click on their mouse to place bids. They could bid on items thousands of miles away without the need for any local representation. As such, the pool of potential bidders for a given good or service was greatly increased and this in turn dramatically improved the efficiency of the auction marketplace itself.

Crucially, the advent of the Internet also allowed for completely virtual auctions to take place. That is to say, an auction could be held where there is no auctioneer or need for participants to be physically present. All the bidding was done online via the Internet and a technology based auction management system monitored the bidding and facilitated the bidding method. This reduced the prevalence of collusion or deceptive bidding practices between the auctioneer and local bidders because there simply aren't any auctioneers or local bidders to collude together. The playing field in a virtual auction is more level and fair than a traditional auction format.

Another advantage of virtual auctions is that items to be auctioned off can be auctioned off simultaneously because the auction management system can handle bidding on many items at once. A live auctioneer typically cannot handle bidding on multiple items at once unless they are supremely skilled at their craft. This ability to simultaneously auction off many items at once has greatly reduced the time needed to conduct the auction itself.

However, there are some drawbacks to entirely virtual auctions if the auction method itself is not optimized. Typically a virtual auction will last for a pre-set length of time that is disclosed to all bidding participants. This encourages the bidders to wait until the last minute and then bid quickly to try to win the item. This rapid bidding at the very end of the auction does not lead to the most efficient auction market and inhibits achieving the optimal price. Also, bidders are entirely reliant on images and descriptions of the items to be auctioned because they cannot physically see them due to the geographic proximity. If the bidders are uncertain they will typically augment their bid with a “risk premium” either underbidding in a regular auction or overbidding in a reverse auction. In both instances the optimal price is not achieved.

Finally, the method through which the auction house generates revenue can have serious flaws. Typically, an auction house will charge a fee for service to the buyer and the seller of the good or service. The fee structures used by various auction houses differ as much as the items each auction house sells. But the fees are typically based on a percentage of the final sales price of the item. In other instances an auction might even take a percentage of the actual final sales price of the good which hurts the seller's profitability. These traditional fee structures can make sellers hesitant to place an item up for auction knowing that their fee obligation could be higher than they'd like depending on the auction outcome. Similarly, a bidder might cease to bid because the financial dynamic of winning the auction at a higher or lower price (for a reverse auction) might be changed due to an increased fee. Stated differently, a bidder can bid at a certain amount because they can afford the fee but bidding any higher would make the financial gain from winning at the higher price negated due to the higher fee imposed.

One segment of our economy that has struggled to optimize both its method and pricing market is in property owner services. Whether it's looking for a repair contractor or carpet cleaning company the method for identifying the right candidate can be time consuming for the property owner. In many cases the property owner doesn't have the expertise to understand exactly what needs to be done and, as such, isn't sure which contractor or contractor type they should pursue. Even if they do identify the right type of contractor or service company they then have the arduous task of seeking out bids to have the service completed.

Traditionally, the method for procuring these bids involves the property owner searching through a phonebook or other source of contact information and calling service providers individually. The service providers then schedule a time to come out to the residence and inspect the job. After they assess the project scope a bid can be given to the property owner to consider. Afterwards, the property owner must repeat this method with other service providers and then compare all of the bids. This method is time consuming and inefficient.

As part of the comparison method property owners need to verify the quality of work the service provider can deliver. To do this the property owners can be given referral sheets from service providers with contact information for prior jobs they have done. Of course, this means the service provider controls which jobs the prospective customer can call on and therefore provides only previous customers who have had a positive experience with the service provider. Further, the property owner is reliant on the referred customer to take the time to discuss the service provider's previous job with the prospective customer. This too is time consuming and inefficient.

The market has recently attempted to address these issues by developing rating companies. Normally these companies solicit feedback on service providers who have enrolled in their system. Property owners can log into the rating company's web portal to assess the potential service provider's ratings and reviews.

However, there are inefficiencies related to selecting a contractor through a rating company. Oftentimes the property owner is required to sort through the service providers within the rating company's system and contact service providers to schedule onsite appointments to receive bids. This requires the property owner to be present in order to receive bids.

Further, the bidding itself is not held in a competitive format such as an auction. Usually only one bid is allowed per service provider and service providers can't compete with one another to find the optimal price. They simply submit their bid in a closed forum and hope that they are selected. Service providers are unaware if their bid is too high when compared with alternative bids meaning that they may lose the job. Nor do service providers know if they are too low and are costing themselves revenue unnecessarily. This system structure requires service providers to guess at what other service providers are bidding and blindly submit a bid for consideration. As such, the service providers are forced to bid their best guess only once and must try to price in their margin and risk premium in an inefficient manner without fully understanding the market demand for providing the service. For their part, property owners can't be sure that they are in fact getting the best possible price. Cheaper service providers might not be able to bid at all as discussed previously and the service providers who do bid are oftentimes bidding inefficiently.

As such, there is a market need for an online virtual open market auction system that changes much of the existing method around selecting a service provider and specifically addresses the timing and fee drawbacks that are prevalent in the market. The new method and structure must also retain and enhance the benefits of the online auction which leads to optimum prices for both buyers and sellers of services. There is also a market need for an auction system that allows service providers to compete for the business of property owner repairs and service opportunities on an equal basis.

### FIELD OF THE INVENTION

The embodiments of the disclosed invention are related to reverse auctions via the internet. More particularly, the invented method and systems relate to virtual interactions between computing devices to conduct a unique reverse auction method for service opportunities.

### BRIEF SUMMARY OF THE INVENTION

Accordingly, the invention disclosed in this application provides for an online reverse auction for property owner services. The invention will provide an auction system and structure that connects property owners that have potential jobs with service providers and/or contractors, hereafter referred to as service providers, who will bid on the job in a live virtual reverse auction.

The initial phase will involve enrolling both the property owner and the service provider into the system. This method will request information from both parties that will be required for the virtual auction to be conducted. After each party has been enrolled, the method will be available for use at all times by both the property owner and the service provider. This system allows smaller service providers a chance to enroll and compete for every job in their service area.

Once the property owner has determined the need for a job for their property the pre-auction phase begins. The property owner will log into the system and post at least, but not limited to, a set of images and/or video and a brief description of the work needing to be done. Based on the information gathered from the property owner about the nature of the job, a notification, either via e-mail, an SMS text message, or other notification within a mobile device application will be sent to all service providers that have registered in the system and provided the required information necessary to do the described work for the property owner.

From the moment this notification is sent, the live/virtual reverse auction will begin. The service providers will be able to immediately access the provided images and/or video and job description via the internet through their computers and/or mobile device or from their mobile device via a mobile device application. The starting price of the auction will be set by analyzing past jobs of a similar nature, information provided by the property owner, or the first bid placed by a service provider. The next bid allowed will be lower than the current bid in keeping with a traditional reverse auction format.

Based on the current existing bid amount each bid placed by a service provider will incur a small “bidding fee”—which will be charged to both the homeowner and service provider—to the provided account on file. As such, there is no fee to post the job and there is no reoccurring user fees to subscribe to the service. All bidding fees are applied on a per bid basis in relation to the bid amount transacted. As an example, if the fee to place a $500 bid on a certain job is $0.25 for both the property owner and service provider, then both the property owner and service provider will be charged $0.25 each for the placed bid. If the fee to place a $1,000 bid is $0.50 for the property owner and $0.35 for the service provider then the property owner will be charged $0.50 and the service provider will be charged $0.35 for the placed bid—a total of $0.85 for the bid transacted.

Bidding will continue with fees being charged on a per bid basis to both the property owner and service provider based on the dollar amount of each placed bid until the property owner's auction price criteria are satisfied or until the time allotted by the property owner expires. The time remaining in the auction will not be shown to service providers which will encourage the service providers to bid immediately and not wait until the very end of the allotted bidding time. This will provide for a more efficient auction market and prevent a rush of bidding at the end of the allotted bidding time. The service provider bids will be retained for review by the property owner at the auction's conclusion.

During the live auction there will be two distinct interfaces for use by the property owners and service providers. The property owner interface is rendered in FIG. 3A in the drawings. The property owner will see at least, but not limited to, the lowest group of bids that have been placed, the name(s) of the service provider(s) who placed them, the next allowed bid increment that can be placed by an auction participant, the total number of auction participants, the amount of time remaining, and the current fees that the property owner will be charged at the auction's conclusion. This interface will be available up until the auction's conclusion. The service provider interface is rendered in FIG. 3B in the drawings. Each individual contractor or service provider will see at least, but not limited to, the images and description of the job they are bidding on, the job's location by zip code, their last bid placed, the next bid range that they can place a bid for, the number of but not the names of any competing service provider(s), and the total fees that they have already incurred for placing bids. This interface will be available up until the auction's conclusion.

Also available to all auction participants will be a request for information posting forum that will be managed by the auction engine and bidding management system. Service providers will be able to request additional information from the property owner in regards to the specific service opportunity that the service provider would like to bid on. Responses from the property owner will be posted for all auction participants to view.

Upon the auction's conclusion a notification will be sent out to the property owner and each service provider who placed a bid during the live auction that the auction is closed. The property owner will receive an ordered list of the final bids for all service providers who participated in the auction sorted by their final bid amounts and detailing at least but not limited to their company name, location, and their internal satisfaction rating. The property owner can then select any of the bids they wish to pursue and have the contact information displayed for each service provider they select. The contact information of the service provider with the lowest bid will automatically be shared with the property owner. The service provider(s) who participated in the auction will be able to view their final bid along with the lowest bid which will be in an amount determined according to each auction. The service provider(s) will then know how their bidding compared to their competitors which will help the service providers bid more efficiently in the future.

Lastly, upon the auction's conclusion, the accrued amount of bid fees for the property owner, up to a fee cap (if reached), will be billed to the account on file for the property owner. Similarly, the accrued amount of bid fees for the service provider(s) at the auction's conclusion will be billed to the corresponding account on file for the service provider(s). Both the property owner and the service provider(s) will receive an itemized receipt detailing the bidding during the auction.

### BRIEF DESCRIPTION OF THE DRAWINGS

FIG. 1 is an illustration of the sign-up and enrollment method;

FIG. 2 is an illustration of the pre-auction method and the workflow establishing the auction settings and criteria;

FIG. 3A is an illustration of the live auction interface that will display on the property owner's screen during the live reverse auction;

FIG. 3B is an illustration of the live auction interface that will display on the service provider's screen during the live reverse auction;

FIG. 4A is an illustration of the post auction screen that the property owner auction participants will see;

FIG. 4B is an illustration of the post auction screen that the service provider auction participants will see;

FIG. 5 is an illustration of the post auction method.

### DETAILED DESCRIPTION OF THE INVENTION

The present invention is facilitated by communications over the Internet but does not include altering the Internet in any way so as to allow the invention to exist and occur. As such—in order to be brief—the details of the Internet, how it functions, how it is structured, and how it underlays this invention are not described here.

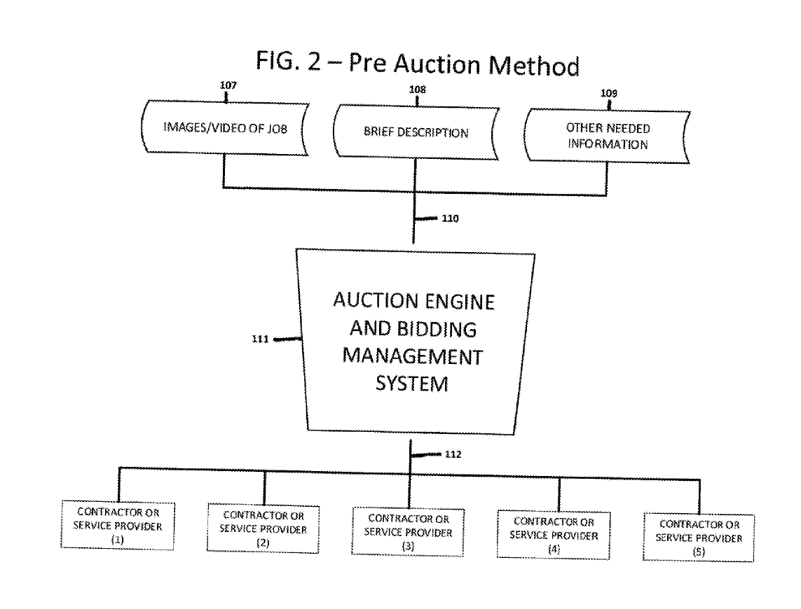

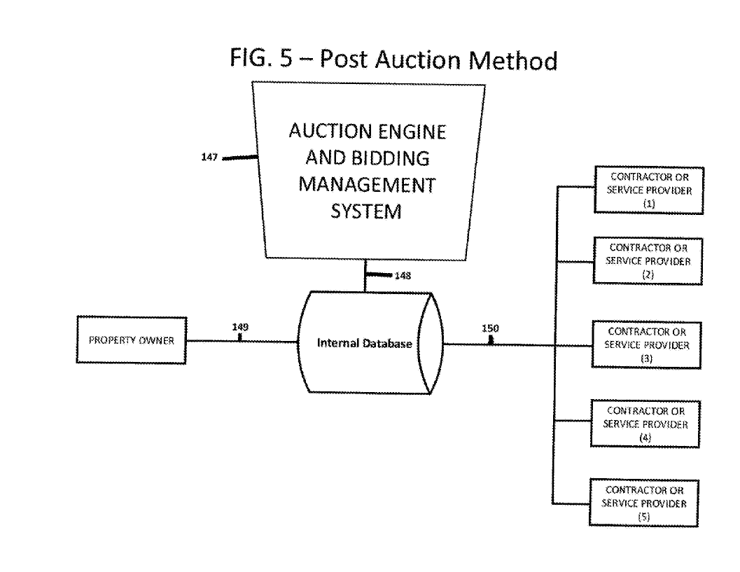

Reference is now made to the figures included in the patent application. Throughout the application unique numerals are used to identify each key feature though a single feature might have different numerals in different renderings. For example, in FIG. 2 the auction engine and bidding management system is labelled as 110 while in FIG. 5 the auction engine and bidding management system is labelled as 147.

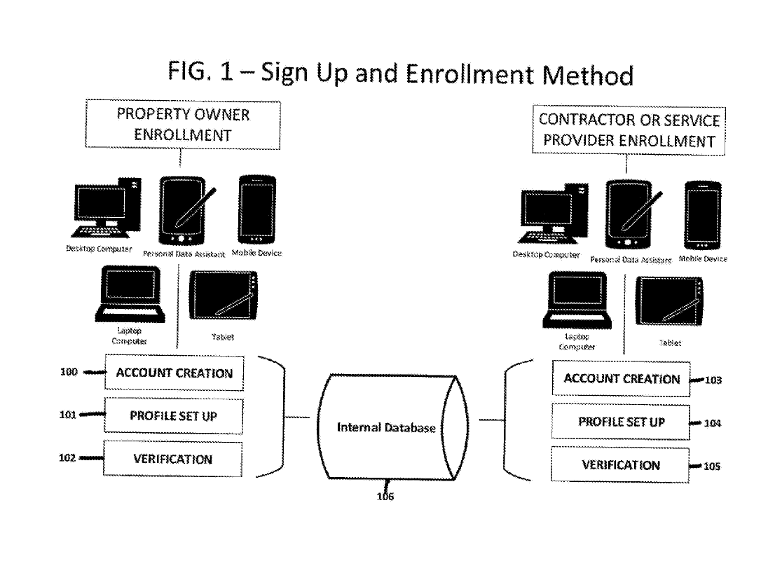

Referring to FIG. 1 a layout of the sign up and enrollment method into the system is displayed. In this embodiment a property owner can access the enrollment screens via logging onto the system via the Internet. The methods for logging in and accessing can include, but are not limited to, desktop computers, laptop computers, personal data assistants, and mobile devices such as tablets or smartphones. When using the device to access the enrollment method the property owner can utilize a website or a mobile application via the property owner's mobile device.

Similarly, service providers interested in participating in the auction can access and enroll through options that include, but are not limited to, desktop computers, laptop computers, personal data assistants, and mobile devices such as tablets or smartphones. When using the device to access the enrollment method the service provider can utilize a website or a mobile application via the service provider's mobile device.

Upon access of the site the user (hereafter meaning either a property owner or service provider) will proceed through three basic steps in the method. The first step in the method is to create an account 100/103 within an internal database. The database will require all of, but not limited to, the following information from a property owner to enroll and join an auction. The property owner must create a username and password and answer a set of questions created within the method. Once the account creation step 100/103 is completed the user will be assigned a unique user number by the system for tracking purposes. Next the user will be required to fill out a profile which will be filed under their unique user number within an internal database 106. In the profile set up phase the user will be required to provide all of, but not limited to, the following: their first name, last name, zip code, and additional account information. Users who identify as service providers will also be required to provide the following (where applicable): professional licensing information, bond coverage information, and certificate of insurance coverage and also self-identify the types of trades, contracting jobs, or services the service provider would like to bid on and also include their geographical service area. The last step of the sign up and enrollment method is for the users to verify their information and submit the provided information into an internal database 106.

Now referring to FIG. 2, the pre-auction method for beginning an auction is displayed. The property owner will commence the auction method by requesting an auction through a user interface. Once the auction has been requested the auction engine and bidding management system 111 will create a unique auction identification number for tracking purposes. The property owner will also provide a name for the requested auction and that name will be used to identify the auction in the user interfaces (discussed later). Afterwards, the property owner will be moved to the pre-auction set up phase where the property owner will provide the information required to categorize and ultimately commence the auction proceedings.

The property owner user has the option to upload photographic images and/or video 107 into the auction engine and bidding management system 111 and must load a minimum preset number. The images will be filed under the unique auction identification number and will only be displayed for that unique auction. The property owner then must provide a brief written description 108 describing the repair work or service opportunity in a manner that allows service providers to understand the service opportunity they could potentially bid on. Lastly, the property owner will be required to provide further information requested by the system to identify the type of work the property owner is requesting and the amount of time the property owner will allow the auction to run before ceasing 109.

Once the required criteria has been provided by the property owner the criteria will then be used to generate a request 110 in the auction engine and bidding management system 111. This request will be sent to the internal database via an internal network linking the auction engine and bidding management system with the internal database. The auction engine and bidding management system will then determine the auction criteria based on information provided by the property owner and create a live auction environment for the auction to exist. Next, the auction engine and bidding management system will analyze known service providers who have expressed an interest or ability in performing similar jobs to the one created by the property owner and invite these service providers to participate 112. The notification will be sent to the service providers via the following, but not limited to, means on FIG. 1: an email notification, an SMS text message to a mobile device, a notification on a mobile device through a mobile device application, and/or a telephone call to a mobile device or smartphone. The service providers will be given access to the live auction environment that they can enter into, review the job listed, determine if they wish to bid on the job or not, and commence bidding if they wish to participate in the auction.

The live auction settings, having been determined by the auction bidding and management system, are immediately populated into the live auction environment. The starting bid for the auction will be the first bid placed by a participating service provider. The auction engine and bidding management system will then determine the next available bid increment based on the starting bid dollar amount.

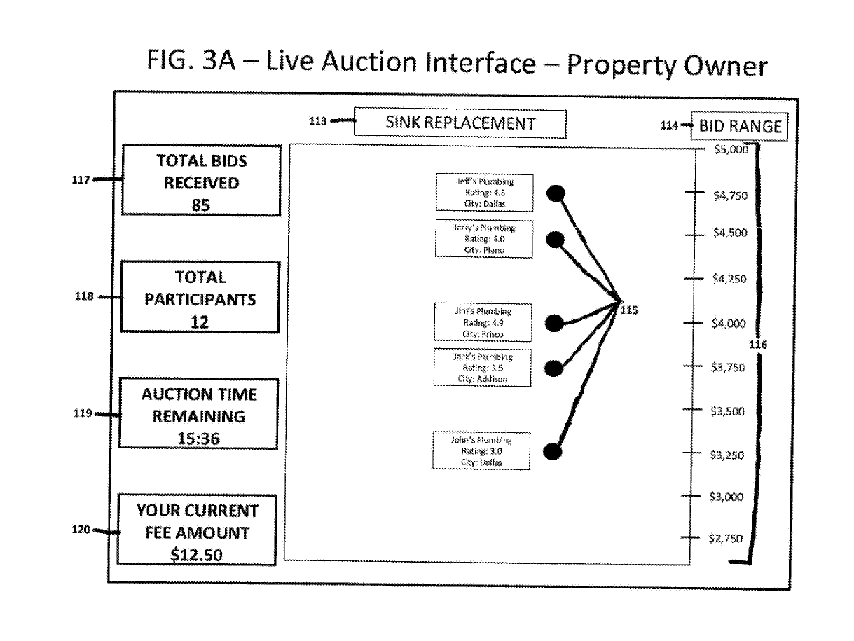

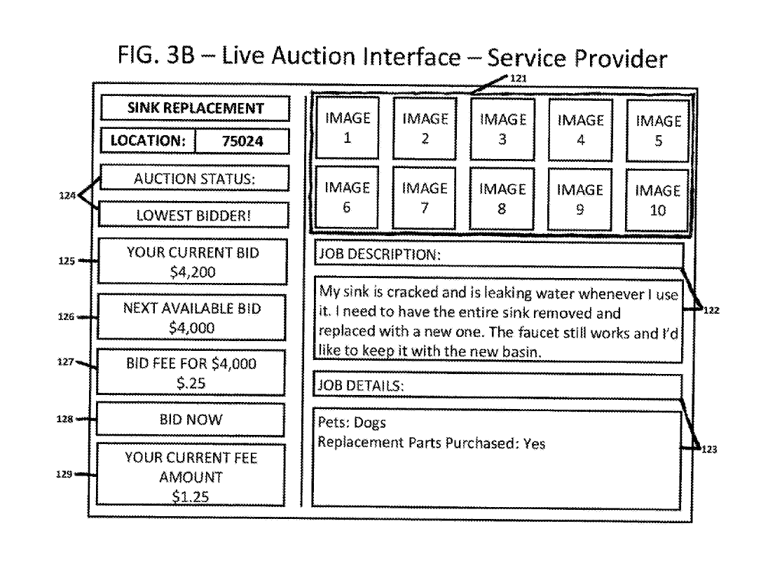

Referring now to FIG. 3A which illustrates the user interface that the property owner will see once the live auction environment has been created by the auction engine and bidding management system. The name of the job 113 that is provided by the property owner during the pre-auction set up request will be displayed across the top. The purpose is to allow users to separate which auction is which if they happen to be running two auctions for two different jobs simultaneously. The name will prevent having to use the unique auction numbers discussed earlier as those could be meaningless to the user. The field name will have a maximum number of characters allowed and will display in all capitalized letters regardless of how the name is entered by the property owner in the pre-auction set up phase.

On the right of the screen at the top the title field of BID RANGE 114 will be displayed to explain the ranges of dollar figures shown below 116. These ranges of dollar amounts are the bid increments that each bidder can choose to select as the price of the auction declines. For example, if the current bid is $4,500 then the next bid available to any bidder would be $4,250 as shown in the nearest range beneath $4,500. The bid increments are for illustration only and should not be interpreted as representing the final structure of bid increments that the invention will employ.

In the center of the screen, boxes 115 with at least, but not limited to, the name of the bidding contractor or service provider, their rating based on internal feedback scores given after the job is completed, and the city based on the zip coded provided to the internal database at the time of the contractor or service provider's enrollment will be displayed. Each will be oriented in ascending order relative to their current bid ranges 116. The number of bidders displayed in this grid will be based on the device being used to view the interface, limitations of technology, and/or user preferences. For example purposes the lowest five of the twelve participants are shown in FIG. 3A.

At the left of the screen, four fields will provide details to the property owner related to the auction's progress. The total number of bids received 117, which refers to the total times a bid has been placed by the auctions' participants. Below the total number of bids received, the total number of participants 118 who have bid in the auction will be displayed. The purpose of these fields is to reinforce to the property owner monitoring the auction that traffic is being generated. Each field will update dynamically as the bidding is happening in the live auction environment. Below the total participants 118 is a display illustrating the amount of time remaining in the auction 119 which is based on the preferences set by the property owner during the pre-auction phase. The clock will display with hours, minutes, and seconds in the standard format HH:MM:SS and will count down in real-time as the auction proceeds. As an example, if the time remaining in the auction is 12 hours, 15 minutes, and 25 seconds the clock 119 will display the time remaining as 12:15:25. Below the auction clock 119 the current amount of total auction fees 120 to be charged to the property owner at the end of the auction as a result of the auction bidding is illustrated. The amount of fees will be displayed in the standard format for United States currency. As an example, if the total fees to be charged to the property owner is 20 dollars and 50 cents, the total fee amount box will display the amount as $20.50 as is standard with United States currency. The total auction fee box will update dynamically as the bidding happens but will not exceed a pre-determined amount based on auction settings.

Now referring to FIG. 3B the user interface that will be displayed to the service provider during the live auction bidding is shown. The name of the job as identified by the property owner in the pre-auction phase is displayed in the upper left corner. The location of the job to be done will be displayed based on the zip code provided by the property owner in the pre-auction phase. To the right and the top are displayed the images and/or video 121 uploaded by the property owner in the pre-auction phase. The images and/or video will be displayed in such a format that they can be selected, opened, and zoomed into via the interface.

Below the images the interface will display the job description 122 provided by the property owner in the pre-auction phase. The text will appear in English and can be selected, opened, and zoomed into on the interface. The purpose of the description is to compliment the images/video 121 to provide the needed information for the service provider to confidently bid on the job. Below the description field is a field detailing any additional details 123 that will be requested of the property owner in the pre-auction phase.

On the left hand side of the interface the auction information and bidding mechanisms is displayed. The auction status 124 refers to the current state of the service provider in regards the other auction participants. The field will display a message such as, but not limited to, “LOWEST BIDDER!” or “OUTBID!”. The color of the text will change depending upon the message being displayed. For example, the text color will display in green when the service provider is the lowest current bidder and the text color will display in red when the user has been outbid by another participant.

Below the auction status fields 124 will be the current bid amount 125 provided by the service provider. As such, the most recent bid amount submitted by the service provider will display and update dynamically as the service provider updates and rebids. The field will display the bid in standard United States currency with a dollar sign. The text of this field will always be green.

Below the current bid amount 125 will be the next available bid amount 126 that the user could bid. That is to say, the next allowable bid that can be placed depending on the current status of the auction bidding. For example, if the current bid is $3,500 and the bid increment for the next bid is $50, then the next available bid 126 will display $3,450 as the auction is a reverse auction. The text in the field will always display in green and will update dynamically as the auction proceeds. The field will display the bid in standard United States currency with a dollar sign.

Below the next available bid field 126 will be the bid fee 127 associated with submitting the bid shown in the next available bid field 126. The text in the field will always display in green and will render in standard United States currency. Below the next available bid fee field 127 will be the dynamic button to submit a bid 128. The button itself will always display the text BID NOW and will submit the amount shown in the next available bid field 126. The button can be clicked by a mouse or selected as part of a touchscreen on a portable mobile device in order to submit the bid.

Lastly, below the BID NOW button 128 the interface displays the total amount of fees 129 to be charged to the service provider user at the conclusion of the auction. The field will always display in green text and will state the current amount of currency accrued during the auction in standard United States currency format with a dollar sign. As an example, if the total amount of fees for bidding to be charged is 1 dollar and 25 cents, the field will be displayed as $1.25 in keeping with standard United States currency.

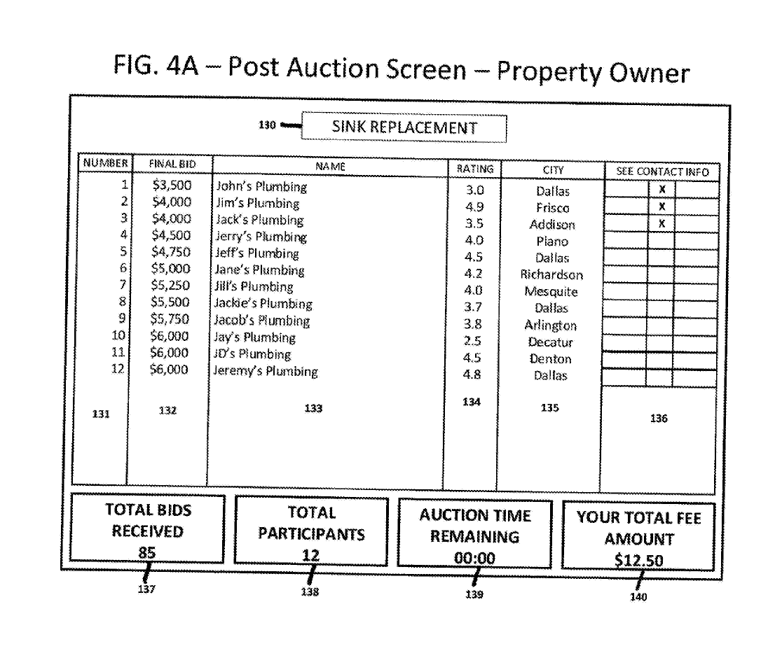

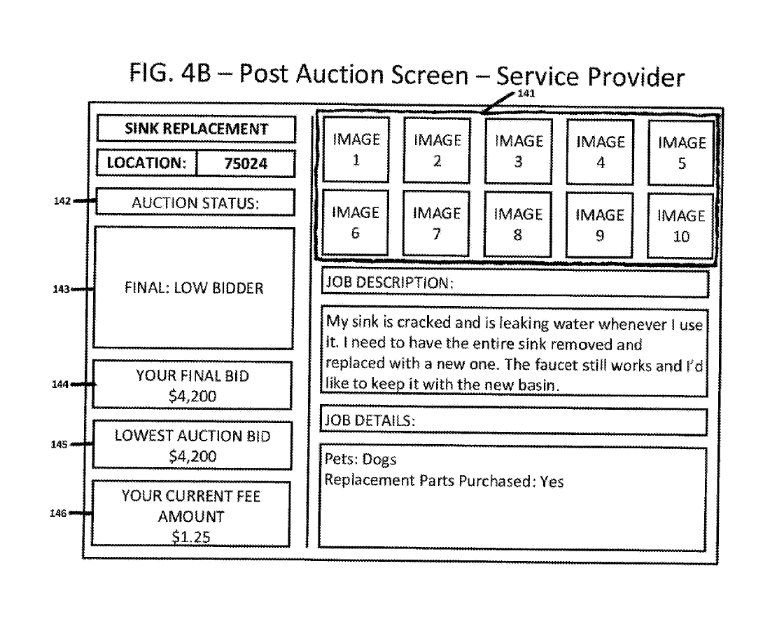

Referring now to FIG. 4A the interface to be shown to the property owner in the post auction phase is rendered. The name of the job 130 as provided by the property owner in the pre-auction phase is displayed at the top of the screen. The field will always display in all capitalized letters regardless of how the name is provided by the property owner in the pre-auction phase. Below the name of the job field 130 a grid will be displayed listing out information related to the final auction outcomes of all the auction participants.

The fields of the grid will begin with a number assigned 131 to each auction participant in descending order based on the final bid amount submitted by each auction participant. The final bid amount 132 for each auction participant is shown in the field to the immediate right of the assigned number field 131. The final bid amount field will always display in green and will render in the standard United States currency format. Next to the final bid amount field 132 the name of each auction participant 133 as provided to the internal database by the service provider during the enrollment phase will be displayed. The next field to the right will display the internal rating score 134 for each auction participant based on feedback scores stored in the internal database for each auction participant. To the right of the internal rating score 134 the city, based on the zip code provided by the service provider during the pre-auction phase, will be displayed 135. Next to the city field 135 selectable fields to view the contact information of the associated service provider auction participant are displayed 136.

The bottom of the interface displays the same fields as shown in FIG. 3A but will display with the final amounts after the auction closes.

Referring now to FIG. 4B the interface to be shown to the service provider auction participants in the post auction phase is rendered. The fields on the right of the screen are the same as shown in FIG. 3B and will not change during or after the auction is completed. For the sake of brevity these fields will not be discussed again.

On the left of the interface the job name, location, auction status 142 and 143, lowest auction bid 145, and current total fee amount 146 fields will also be rendered exactly the same as shown in FIG. 3B but updated post auction and will not be detailed further.

The final bid field 144 will be displayed beneath the auction status field 143 and will indicate the final bid placed by the service provider. The field will always display in green text and will follow standard United States currency formats as previously detailed.

Referring now to FIG. 5 the post auction method for both property owner and service provider users is displayed. At the conclusion of the auction, the auction engine and bidding management system 147 will send all auction data 148 including, but not limited to, the auction participants as defined by unique identifier, the number of bids submitted by each auction participant, the duration of the auction, the individual bids submitted by each auction participant, the final lowest bid of each auction participant, and the selected auction participants whose contact information is requested by the property owner user in the post auction interface detailed in FIG. 4A to the internal database. The internal database will then store the final auction outcomes transmitted to the internal database by the auction engine and bidding management system 148 for use in future analysis and to have it readily available if needed at a later date. At this point, the internal database will now calculate the fees to be charged to the property owner that posted the job and the service providers that bid on the posted job as displayed in FIG. 4A and 4B in the total auction fee fields 120 and 129 and will charge the account provided by the users in the enrollment phase for the amount accrued during the auction 149 and 150. Lastly, a receipt will be transmitted to the property owner 149 and each of the service provider auction participants 150 who have had their account charged for the bid fees associated with their participation.

What is claimed is:

1. A method for conducting live, virtual online reverse auctions for property owners' services facilitated over the Internet via mobile and traditional computing devices, said method comprising of:
enrolling the property owners and service providers into an internal database system;
gathering specific information to set up user profiles for the service providers that include, but are not limited to, company name, zip code, professional licensing information, bond coverage information, certificate of insurance coverage, types of trades qualified for, geographical service area, and additional account information;
gathering specific information to set up user profiles for the property owners that include, but are not limited to, the property owner's first name, last name, zip code, and additional account information;
automatically verifying the provided information utilizing public resource databases;
an internal database system through which property owners can create auctions by engaging an Internet based system, uploading a set of images and/or video, writing a description about the service they are requesting, and providing other information as required to conduct the auction;
an auction engine and bidding management system responsible for facilitating the auction and managing the bid traffic and volume;
automatic communications to users of auction starts with service providers enrolled in the system via Internet or wireless communication through personal computers, mobile devices, smartphones, tablets, laptop computers, and mobile device applications developed for portable mobile devices;
a posting forum allowing for service providers to request additional information about the service opportunity from the property owner and the responses being displayed to all auction participants;
charging a fee on a per bid basis to both the property owner initiating the auction and the participating service providers who bid on the property owner's service request posting, said fees are based on a predetermined dollar amount for each specific predetermined bid range.

2. The method for claim 1 further comprising of a live auction display to be shown to property owners during the live auction comprising of at least, but not limited to, a graphical display of the lowest bids in a grid structure, the total number of bids received, the total number of auction participants, the auction time remaining, and the total fee amount to be charged to the property owner.

3. The method for claim 1 further comprising of a live auction display to be shown to service providers during the live auction comprising of at least, but not limited to, a graphical display of the uploaded images and/or video, written description of the job, additional job details, current auction status, current bid, next available bid, next available bid fee, current fee amount, and property owner provided details of the job.

4. The method of claim 2 further comprising of live auction fields that update dynamically to changing auction conditions and are visible in real-time through the stated display of claim 2.

5. The method of claim 3 further comprising of live auction fields that update dynamically to changing auction conditions and are visible in real-time through the stated display of claim 3.

6. The method of claim 3 further comprising of a dynamic BID NOW button that will automatically submit the next available bid into the live auction environment on behalf of the service provider user after being selected by the service provider user.

7. The method of claim 1 wherein at the conclusion of the auction a display is shown to the property owner showing at least, but not limited to, the final lowest bids of each auction participant, company name, internal rating, city, and selectable fields for contact information of all of the service provider auction participants, total bids received, total participants in the auction, auction time remaining, and total accrued fee amount.

8. The method for claim 7 further comprising of a dynamic button in the field for contact information for each service provider auction participant allowing the property owner who initiated the auction to select which auction participants they want to see the contact information of.

9. The method of claim 1 wherein at the conclusion of the auction a display is shown to the service provider showing at least, but not limited to, the uploaded images and/or video of the service requested by the property owner, the job description, any additional job details as provided in the pre-auction method, the final auction status of the service provider user, the final dollar amount bid by the service provider user, the lowest auction bid of any participant in the auction, and the total dollar amount of fees to be charged to the service provider.

10. The method of claim 1 wherein at the conclusion of the auction the auction engine and bidding management system will notify an internal database of the auction's conclusion and share details about the auction with the internal database that include, but are not limited to, the total amount of bids, the record of bids per each auction participant, the final lowest bid per participant, the unique user numbers for each auction participant, the total fee dollar amounts to be charged to the property owner and the service providers as a result of the auction.
